(19) United States
(12) Patent Application Publication
(10) Pub. No.: US 2016/0258461 A1
(43) Pub. Date: Sep. 8, 2016

(54) CONNECTOR ASSEMBLY FOR TEMPORARY CONSTRUCTIONS

(71) Applicants: Edwin Jeroen MULLER, TA Delft (NL); BUILDEX (F.E.) LIMITED, Wanchai, Hong Kong (CN)

(72) Inventors: Edwin Jeroen Muller, TA Delft (NL); Jakov Yoav Karasanti, Ningbo (CN); Emiel Dimitri Karasanti, Ningbo (CN); Yusheng Li, Jiaojiang District (CN)

(21) Appl. No.: 15/028,909

(22) PCT Filed: Jan. 23, 2015
(86) PCT No.: PCT/NL2015/050042

§ 371 Date: Apr. 12, 2016

(30) Foreign Application Priority Data
Jan. 24, 2014 (NL) 2012134
Jun. 4, 2014 (NL) 2012947

(51) Int. Cl. F16B 5/06; A47B 37/04; A47C 1/14; A47B 3/06; F16B 12/20; A47D 13/06; A47B 96/06; A47B 47/00; F16M 11/24; A47D 3/00; A47D 1/00; A47D 7/00

(52) U.S. Cl. CPC F16B 5/0607; A47D 1/006; A47B 37/04; A47C 1/14; A47B 3/06; A47D 7/005; A47D 13/066; A47B 96/06; A47B 47/0075; F16M 11/24; A47D 3/00; F16B 12/20

(57) ABSTRACT

A connector assembly (200) comprising a body (203) having two U-shaped sections (201,202) each section having two opposed arms (204,205) having a hole (207,208) and a locking device (209,210) having an elongate locking member (215,216) extending through the holes of each arm. A first and second latching member (212,213) are attached to each respective end of the locking member (215, 216) abutting against an outward surface of the respective arm (204,205). The locking member comprises a first elongate body (215) having a first diameter attached with one end to the first latching member (213), and a second elongate body (216) that is connected to the first elongate body (215) movably along a longitudinal axis (L). The second elongate body (216) comprises a second diameter being smaller than the diameter of the first elongate body and being attached with one end to the second latching member (212).

The invention relates to a connector assembly, a panel for use in such a connector assembly and to a connector system comprising a connector assembly and at least two panels.

Such systems may be used for the construction of furniture, such as children's furniture, garden furniture, among which tables, children's beds, play pens, chairs, cupboards, shelves and the like. Other temporary constructions such as booths, sheds, stands and other temporary structures that need to be rapidly erected and need to be easily and rapidly disassembled into easy to handle parts that can be transported and stored in a space-efficient manner.

In the prior art, many ways have been developed to fasten parts of assemblies, such as connect boards. An example thereof is a mortise dowel joint as well as connections in which perpendicular boards are connected by means of a cross nut inserted in a hole in one blank, in which nut a screw is fastened, connecting the perpendicular board. Many home assembly cupboards are based on this principle.

The known ways of fastening require complex and simultaneous handling of several parts.

It is an object of the present invention to provide a connector assembly that can be easily installed and dismantled. It is a further object of the invention to provide a connector assembly that can be applied and disconnected without the use of tools. It is a further object of the invention to provide a versatile connector assembly for connecting two or more panels, which panels are substantially flat and can be compactly stacked with abutting flat surfaces.

Hereto the connector assembly according to the invention is characterised by a body having two generally U-shaped sections each section having two opposed arms having a hole and a locking device having an elongate locking member extending through the holes of each arm, a first and second latching member attached to each respective end of the locking member abutting against an outward surface of the respective arm, wherein the locking member comprises a first elongate body having a first diameter attached with one end to the first latching member, and a second elongate body that is connected to the first elongate body movably along a longitudinal axis, the second elongate body having a second diameter that is smaller than the diameter of the first elongate body and being attached with one end to the second latching member.

The body can be applied to interconnect two panels that are received with their width between the arms of the U-shaped sections. Each panel comprises a circumferential edge and a slot having a length direction extending through a thickness of the panel. The slot has a wide channel section situated at a distance from the circumferential edge and a narrow channel section communicating with the wide channel section and being open to the circumferential edge. When the panel is inserted between the U-shaped arms, the first elongate body is retracted such that the second, narrow elongate body bridges the space between the arms. When the panel is inserted between the arms of the U-shaped section, the narrow elongate body passes in a direction transversely to the peripheral edge, through the narrow channel section into the wide channel section. The narrow channel section has a dimension smaller than the first elongate body and allowing the second elongate body to pass from the circumferential edge into the wide channel section.

Next, the first elongate body is moved in its length direction to enter into the wide channel section until the locking members about against the outside surfaces of the arms of the U-shaped section, such that the body is locked to the panel.

The first elongate body may comprise a cylinder comprising a screw thread along which the second elongate can move by turning of the locking member (for instance a spherical or disc-shaped knob). Preferably the second elongate body if formed by an elastic wire connected to the cylindrical first elongate body.

The present invention allows the panels to be of simple and flat construction only being provided with a number of channels through their thickness that are in open communication with the peripheral edge of the panels. Hence the panels can be easily stacked for storage and transportation and can be assembled into the required three-dimensional form by connecting to the connector bodies without the use of any tools.

When applying the connector assembly of the present invention, it becomes e.g. possible to assemble furniture or toys based on boards or sheets by means of simple manual steps. An advantage thereof is that the parts, such as the boards or the sheets, may be packaged, and transported towards the end user in a flat stacking on top of each other. A further advantage is that the furniture or toys can be disassembled after use and can be stored until later use with minimal use of space. A further advantage is that parts may be easily replaced for e.g. altering the attention value of the product, by e.g. exchanging elements by elements with a different colour or different design.

Further areas of use for applying a fastening assembly according to the present invention relates to e.g. a window extender, clothing hooks, carriers for shelves, but the areas of use are not limited to these examples.

In one embodiment of a connector assembly according to the invention, the body is of generally rectangular shape with the U-shaped arms of the sections situated on opposite end sections of the body with their arms extending substantially in the length direction of the body. This provides a connector for connecting two panels extending in the same plane.

Another connector assembly according to the invention has the body with two end parts extending at a mutual angle of substantially 90 degrees, the U-shaped sections being situated in each end part. This provides a connector for connecting two panels at a 90 degree angle.

For connecting three panels, a connector assembly according to the invention has a body comprising three end parts arranged in a generally T-shaped configuration, a U-shaped section being situated in each end part.

For connecting four panels, a connector assembly according to the invention has a body with four end parts arranged in a generally cross-shaped configuration, a U-shaped section being situated in each end part.

A panel for use in the inventive connector assembly comprises a circumferential edge and a slot having a length direction extending through a thickness of the panel, the slot having a wide channel section situated at a distance from the circumferential edge for receiving, and a relatively narrow channel section communicating with the wide channel section situated near the circumferential edge and being open to the circumferential edge.

A connector system according to the invention is composed of a number of rectangular, bent, T-shaped and cross-shaped bodies, and comprises multiple panels.

According to an embodiment, in the fastening assembly, the channel has at least partially a diameter for receiving the locking member, preferably from one side of the channel, therewith forming a locking channel. This provides an advantageous embodiment for providing a mutual locking of the receiving element and in the insertion element by means of the locking member. It is envisioned that use of one channel suffices for such an embodiment.

In a further embodiment it is envisioned that at least one end of the channel ends at an edge of the receiving element, further preferably in which two ends of the channel end at two edges of the receiving element. Because of this, advantageously, a firm and two-sided attachment can be realized in which for example jiggle or play according to a one-sided connection is prevented.

According to a further embodiment, in the locking assembly, two latching members are arranged at two respective ends of the biasing member, in which the biasing member is elongated. By means of this, a simple mounting and operating is provided. A user, even a small child, can pull a latching member that is for example embodied as a bead for freeing the locking member from the insertion elements.

Further, a fastening assembly is provided in which a first latching member of the locking assembly is suitable for placement in a latching member recess for therein fastening of an end of the biasing member, and a second latching member of the locking assembly is suitable for operating the locking assembly by pulling the second latching member. Such an embodiment is single-sidedly operable for a fastening assembly at the edge of for example a blade element in which the locking assembly is directed inwardly from the edge.

Further, both latching members of the locking assembly are suitable for operating the locking assembly by pulling thereof. Such an embodiment is two-sidedly operable, as a locking member may be operated from two sides by means of the latching members. Because of this, and insertion element may be fastened from two sides, which requires a slightly more complex assembly but also prevents inadvertent disassembly because disassembly has to be initiated from two sides before disassembly occurs. Furthermore, by means of one double-sided locking assembly, two or more insertion elements may be.

By means of an assembly in which an end of the channel ends in the latching member recess, preferably embodied as an opening, through hole or recess, that is arranged at an end of the channel at a distance from an edge of the receiving elements, fastening of the non-operated latching member of a single-sidedly operable latching member is achieved in an advantageous manner.

Furthermore, one of the two latching members is maybe arranged in a respective latching member recess. Because of this, the biasing member may be kept under bias from the side. In case the fastening of the latching member to the biasing member is realized during production, it is a further advantage that the fastening assembly may be packaged and handled as sheet parts in which no parts extend beyond the surfaces of the sheets, such that a stack of sheets is not thicker than the sum of the thickness of the individual sheets. This forms, next to for example the easy assembly and disassembly due to no loose parts being required for assembly, is an important advantage of the present invention. This is advantageous in case there are one or two latching member recesses per locking assembly for holding the respective latching members.

In a further embodiment, the fastening assembly comprises a biasing member access slot for providing access of the biasing member to the channel, which is preferably arranged at a location of the part of the channel that forms the locking channel in an insertion direction of the insertion member, wherein the biasing member access slot is connected with the edge of the insertion member. Herewith, in a simple manner, it is realized that the insertion member can be inserted in the receiving element, whereby the biasing member and the bias is capable of bringing the locking member into the locking position.

Further, the receiving element comprises a reinforcement slot for reinforcing the coupling between the receiving element and the insertion element, in which preferably the reinforcement slot is arranged in an extension direction of the insertion element relative to the receipt position. In for example the table embodiment as described below, this reinforcement slot provides the option of inserting an extra supporting part into the tabletop which increases the carrying strength as well as the resistance to horizontal push forces.

In an embodiment in which the insertion element is suitable for coupling with a receiving element by means of two or more fastening assemblies, it is achieved that several plate elements can be coupled to several legs for forming a table or several boards in a cupboard. With more complex constructions, further respective construction possibilities are possible, such as hinge-able constructions that are described in the following under reference to the drawings.

Applying a receiving position at an angle of between 45-135° relative to a surface of the receiving element, provides an additional reinforcement against for example horizontal or transverse forces but also for example appearance advantages such as in cases in which this feature provides a familiar character for e.g. a table.

In a further embodiment, the insertion element comprises a receiving slot for receiving a receiving position holding part of the receiving member, wherein a bottom of the receiving slot fulfils the function of the insertion member, preferably comprising a respective biasing member access slot, which further preferably provide access to a respective locking channel part in the respective insertion member.

In a further embodiment, one or both of the latching members cooperate with of the receiving element, that may be designed for the optimal grip or a high attention value. The shape may be shape of a bead, but also a shape that extends flush in cooperation with a surface of the receiving element. Herewith, either remarkability or discreteness of the latching member may be achieved. Furthermore, a high level of grip may be provided or that contrarily no grip depending on the application. Grip in itself is advantageous for latching members that serve the purpose of operating the latching members, but even in such cases, operability may be sacrificed for a noticeable or discrete exterior.

In a further embodiment two receiving positions share a channel for mutual application of a latching assembly, in which the channel preferably extends from the receiving positions in both directions, in which further preferably one or two locking channels are formed in the channel.

A further aspect of the present invention relates to a latching assembly according to the present invention for use in a fastening assembly according to the present invention.

A further aspect of the present invention relates to a receiving element according to the present invention for use in a fastening assembly according to the present invention.

A further aspect of the present invention relates to an insertion element according to the present invention for use in a fastening assembly according to the present invention.

These embodiments provide advantages as described relating to the above described aspects.

Further advantages, features and details of the present invention will be further elucidated on the basis of a description of one or more exemplary embodiments with reference to the accompanying figures. In the figures:

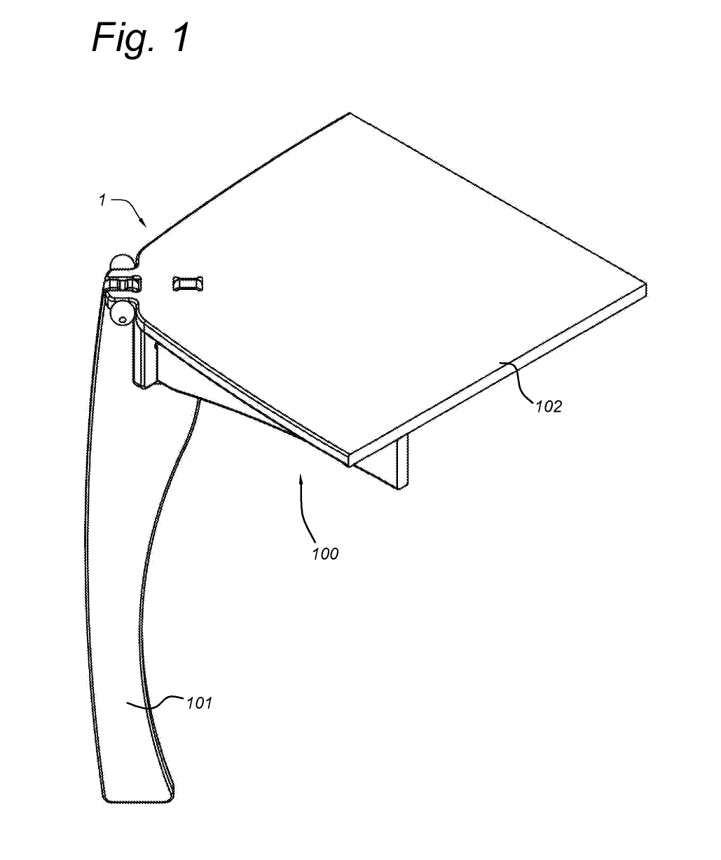

FIG. 1 relates to a first embodiment of a fastening assembly of a part of a table.

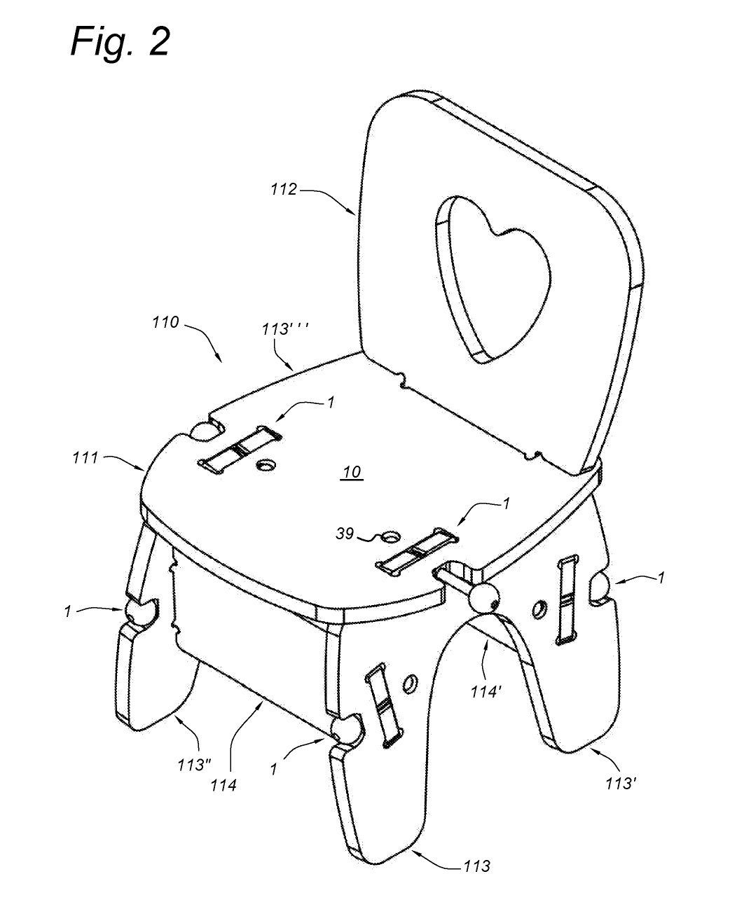

FIG. 2 relates to a further embodiment of a fastening assembly of a part of a chair.

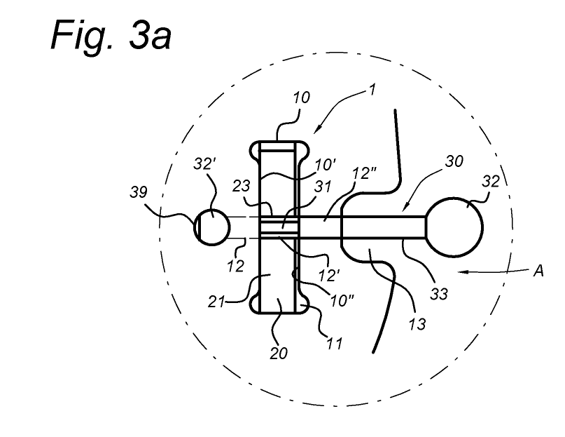

FIG. 3 relates to a further embodiment of a fastening assembly shown in detail.

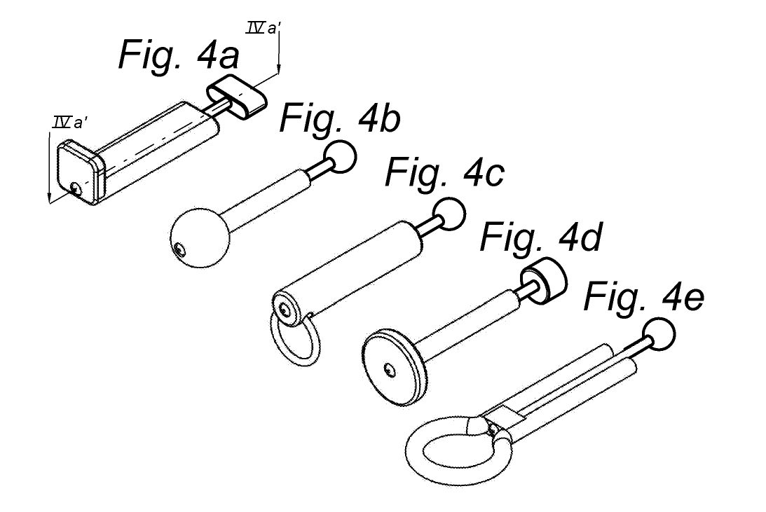

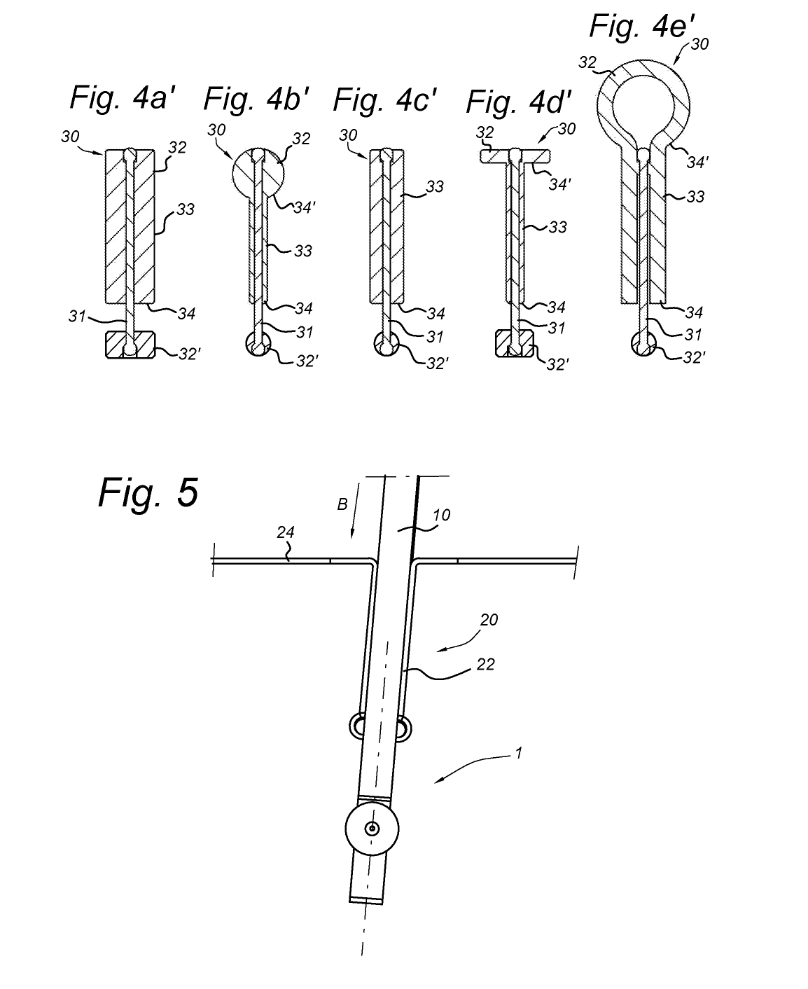

FIG. 4 relates to a further embodiment of a fastening assembly.

FIG. 5 relates to a further embodiment of a fastening assembly.

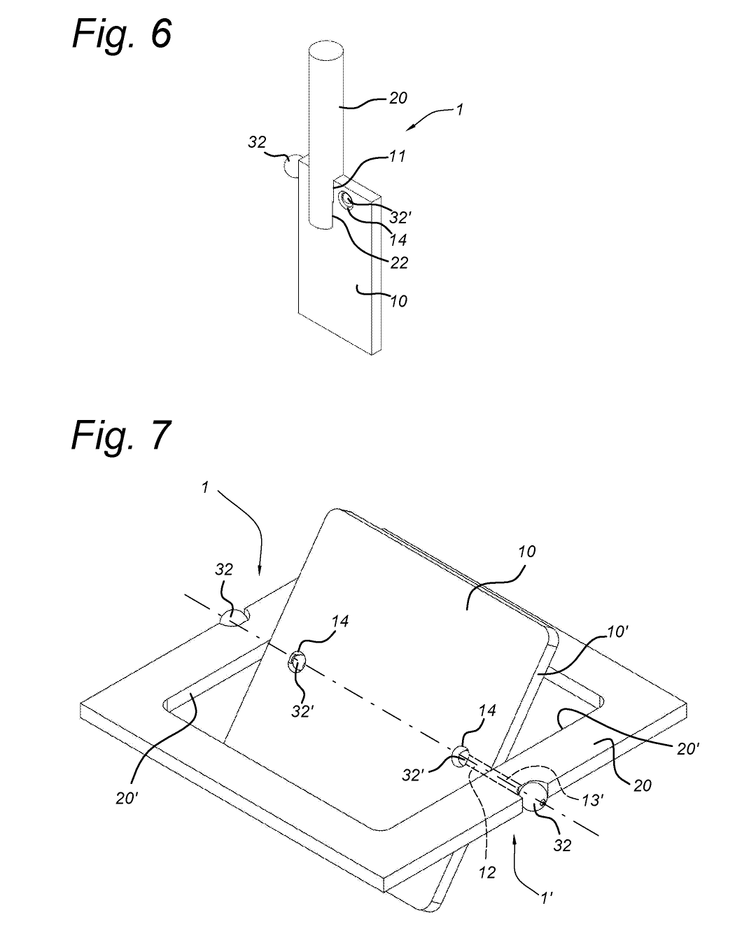

FIG. 6 relates to a further embodiment of a fastening assembly.

FIG. 7 relates to a further embodiment of a fastening assembly.

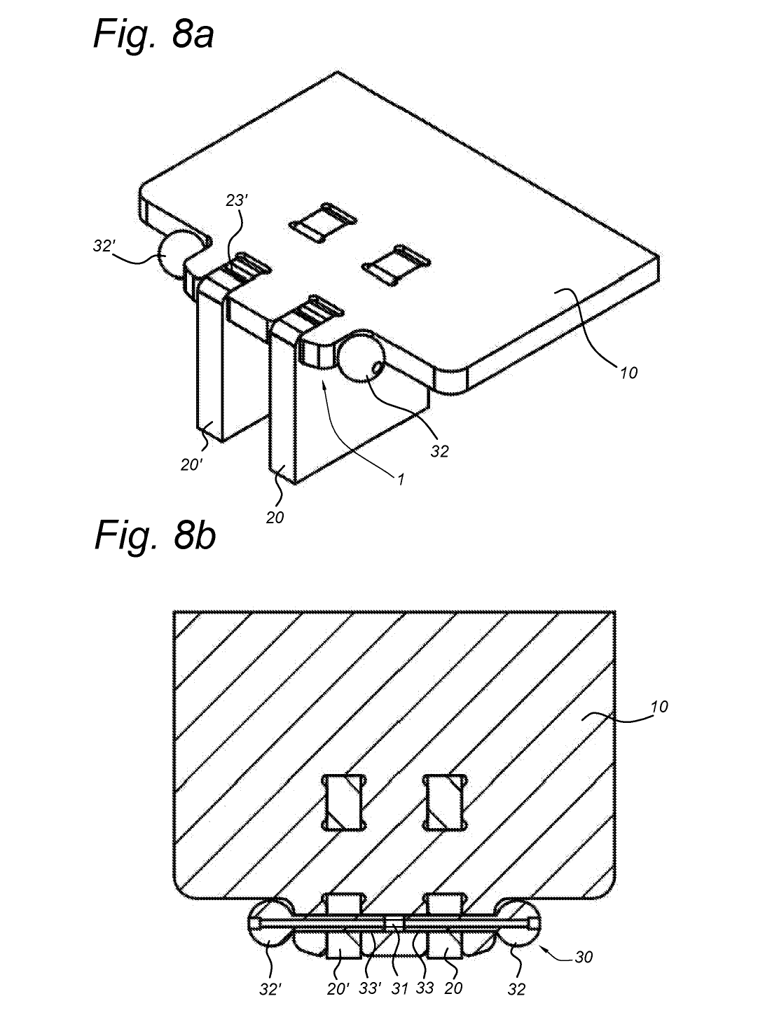

FIG. 8 relates to a further embodiment of a fastening assembly.

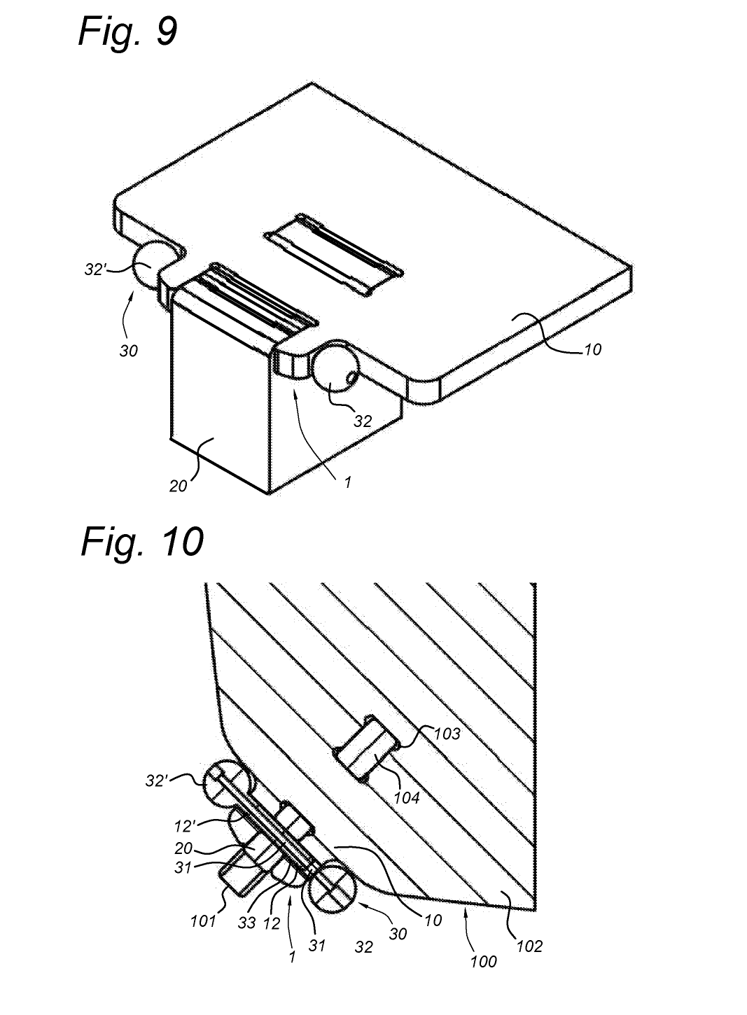

FIG. 9 relates to a further embodiment of a fastening assembly.

FIG. 10 relates to a further embodiment of a fastening assembly,

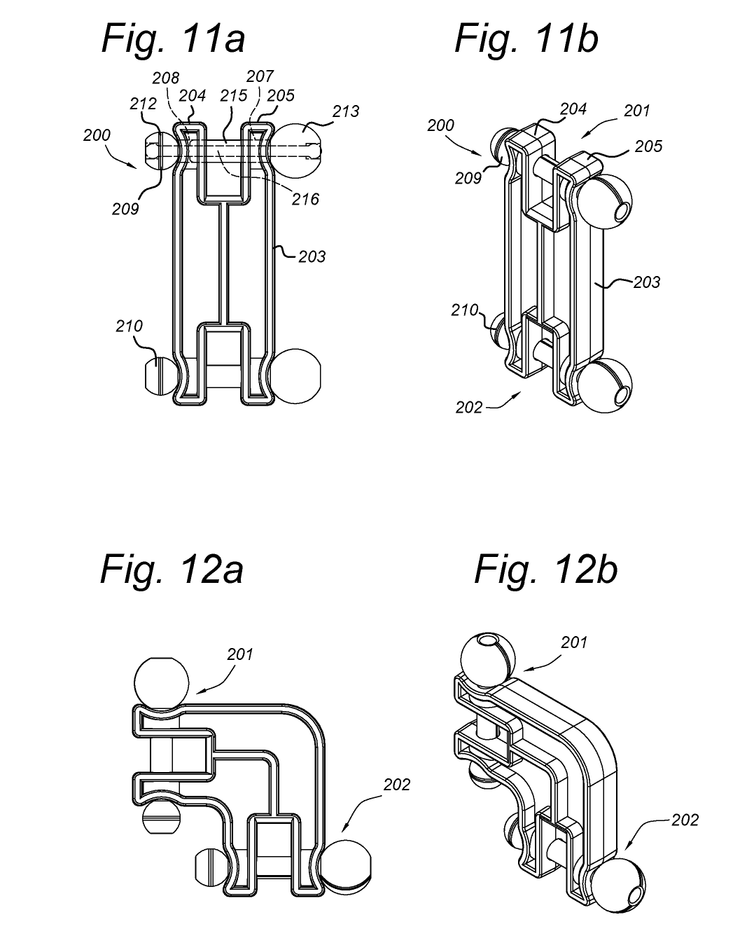

FIGS. 11a and 11b show an embodiment of a connector assembly for connecting two panels in the same plane,

FIGS. 12a and 12b show an embodiment of a connector assembly for connecting two panels at a 90 degree angle,

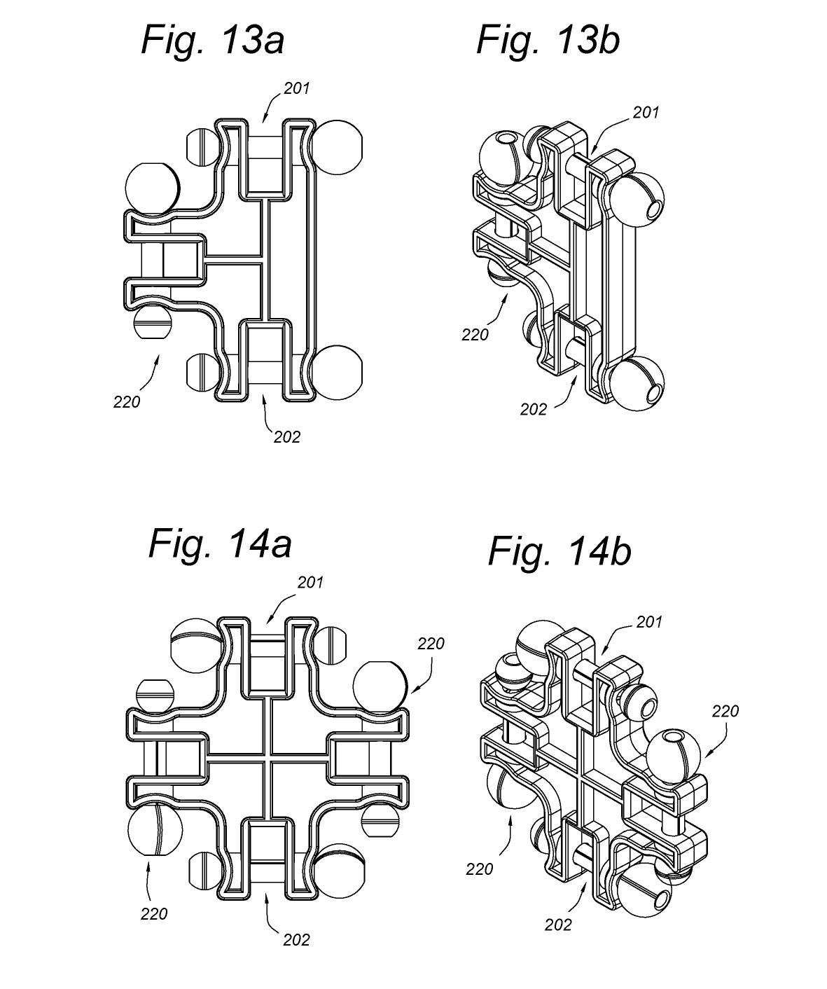

FIGS. 13a and 13b show an embodiment of a connector assembly for connecting three panels,

FIGS. 14a and 14b show an embodiment of a connector assembly for connecting four panels,

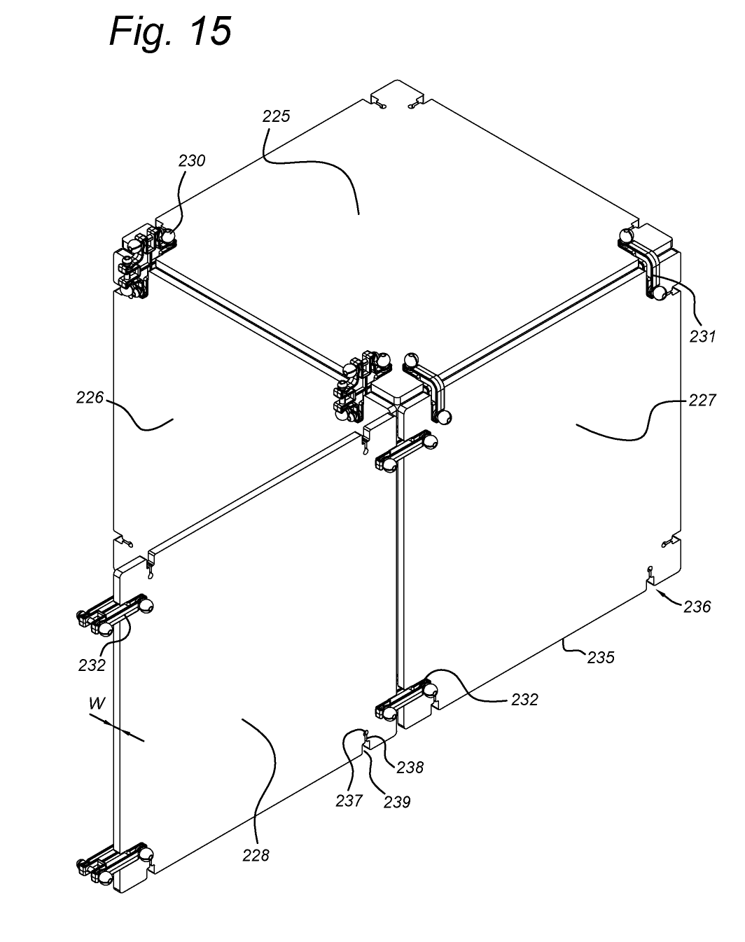

FIG. 15 shows a connector system connecting four or more panels in a generally cubical arrangement,

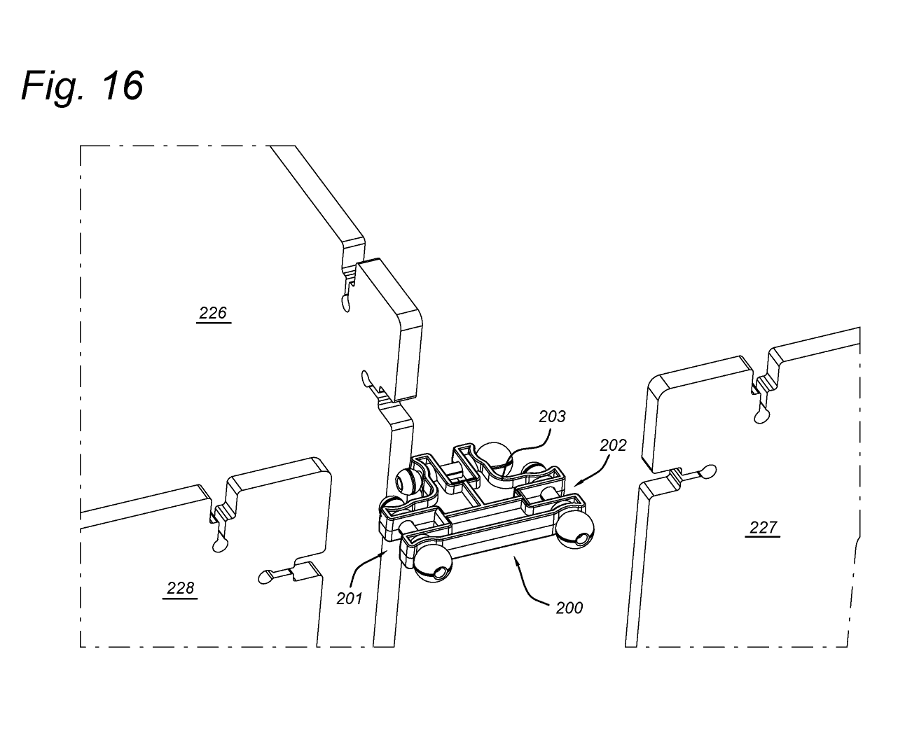

FIG. 16 shows an exploded view of the connector system according to an embodiment of the present invention, and

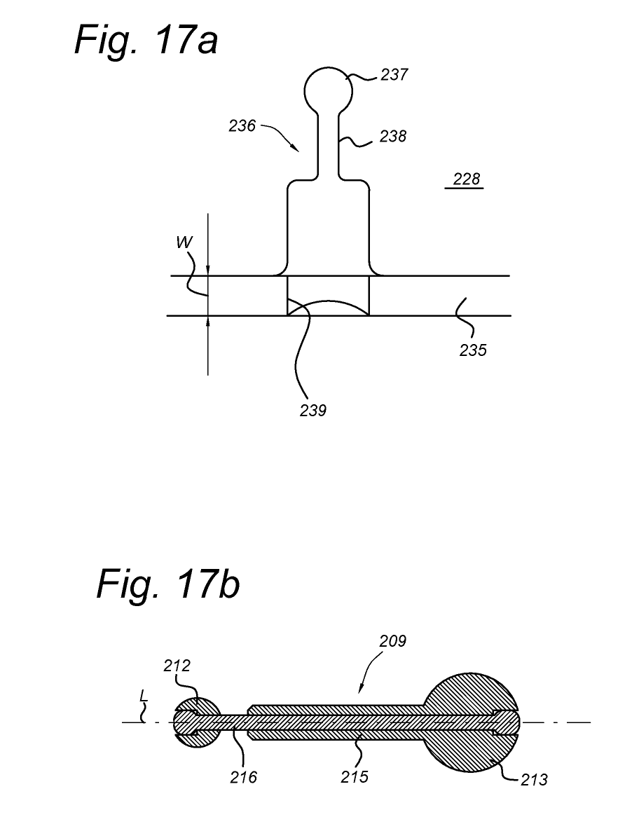

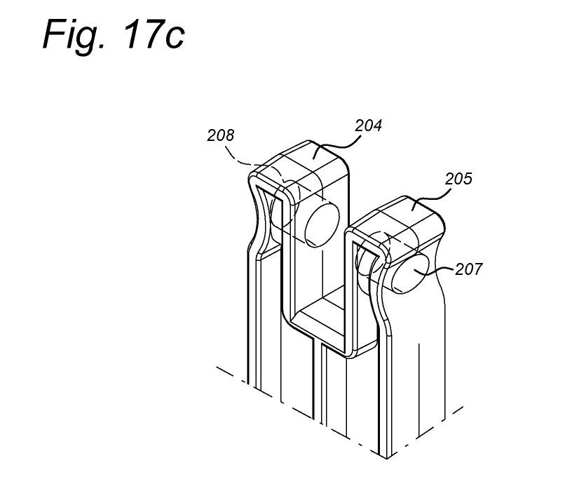

FIGS. 17a-17c show a detailed view of the connector system according to the present invention.

An embodiment (FIG. 1) according to the present invention relates to a fastening assembly 1 which is applied in a table 100. The table comprises a table leg 101, table top 102 and a fastening assembly 1, wherein the tabletop serves as a receiving element, the leg serves as insertion element and the respective parts of the fastening assembly in this preferred embodiment are part of the tabletop and the table leg. Preferably, at least all table legs are fastened to the tabletop by means of fastening assemblies 1, such as described in greater detail below.

A further preferred embodiment (FIG. 2) according to the present invention finds application in a chair 110. The chair comprises a seat 111, backrest 112, chair legs 113, 113′, 115″, 113′″ and cross connections 114, 114′, wherein preferably a cross connection 114′ and a backrest is created as one part. The distinct parts of the chair are preferably all mutually fastened by means of respective fastening assemblies 1.

An aspect of this embodiment is that the seat of the chair serves the purpose of receiving element for the two shown fastening assemblies. These two fastening assemblies for which the seed serves the purpose of receiving element, the legs 113, 113′ respectively 113″, 113′″ serve the purpose of insertion element. However, for the connections with the cross connections 114, 114′, the legs serve the purpose of receiving element.

In FIG. 3, a fastening assembly is shown in detail. This fastening assembly comprises a receiving position 11, an insertion member 20 and a locking assembly 30. The receiving element 10 comprises an operating recess 13 that is arranged at one side of the receiving element. From the operating recess a first part of a channel 12′ that is formed in the receiving element extends. The channel connects the operating recess with a receiving position 11. Following on from the first part of the channel, at an opposing side of the receiving position, a second part of the channel 12 is arranged, wherein the second part of the channel connects the receiving position with a latching member recess 39.

The insertion member 20 is inserted in the receiving position of the receiving element. The insertion member is preferably elongated for providing additional firmness to the fastening assembly.

The locking assembly is shown in FIG. 3 in an extended condition for allowing placing of the insertion element in the receiving position. The locking assembly comprises a biasing member, such as an elastic member and or pulling member that is preferably elongated for causing of a pulling together force in the extended condition. In the extended condition, the biasing member is present in the receiving position in a stretched out condition wherein the locking member is present in the general part 12′, the recess 13 and/or outside thereof. The biasing member access slot 23 is arranged as a side of the insertion member for allowing access of the biasing member. The biasing member is suitable for insertion thereof through the biasing member access slot. In the locking position, the locking member extends through the channel part 12, locking channel that follows on from the channel part 12 through the insertion member and the channel part 12′.

The locking assembly comprises to latching members 32, 32′ for keeping the biasing member 31 under bias. A first locking member 32′ is arranged in the locking member recess 39 for keeping therein of the first locking member. A second looking member 32 is arranged at the operating recess 13 in a locking position. In the extended condition, such as in FIG. 3, the second latching member is kept under bias in the direction of the arrow A by means of the biasing member.

The biasing member 31 extends from the latching member 32′ to which it is fastened to the latching member 32 to which it is fastened.

The operating recess 13 serves the purpose of providing reachability to the latching members 32 for taking out the fastened condition of the locking assembly. A further advantage of arranging the latching member in the operating recess is that the latching member is at least partly arranged within the shape of the receiving element and therefore poses no hindrance to the user during use of the furniture.

The second latching member 32 comprises a locking member 33. The locking member preferably comprises a recess or hollow space along the longitudinal axis for arranging in there of a part and or end of the biasing member. By means of this recess or hollow space an additional space is provided for advantageously providing space for a relatively long biasing member with a relative small ratio between the length in extended condition and in the locking condition of the biasing member. This advantageously provides that a biasing member with relatively less elastic reach can be used. In the locking condition, the locking member extends over at least a part of the receiving position, preferably the whole receiving position, further preferably a part of channel part 12, channel part 12′ and the whole receiving position. Because the locking member cannot pass through the biasing member access slot, it is achieved that the inserted insertion member is locked into the receiving position when the locking assembly is in the locking condition. Further preferred embodiments (FIG. 4) according to the present invention relates to a number of locking assemblies 30. These locking assemblies 30 each comprise a biasing member 31, two latching members 32, 32′ and a locking member 33.

The different locking assemblies comprise latching members 32, 32′ with different shapes for arranging in preferably complementary shaped latching member recesses 39 and operating recesses 13 depending on the purpose of the exterior thereof, such as described in the above.

A further embodiment (FIG. 5) according to the present invention relates to a fastening assembly for fastening of two flat elements under a different usual orientation then described in the above. In this embodiment, the insertion member also comprises a receiving slot 22 for partially receiving of the receiving member. By means of the overlap that is provided after insertion, a relatively strong fastening is achieved.

The fastening is achieved by means of partly shifting into each other of the elements. During insertion in a direction of the arrow B of the receiving element in the insertion element, the receiving element is inserted into the receiving slot 22.

The longitudinal axis C of the intercession element is oriented under an angle relative to his side 24 of the receiving elements. Furthermore, this embodiment functions with a locking assembly in a channel in a similar manner as the embodiment shown in FIG. 3.

A further preferred embodiment (FIG. 6) relates to a fastening assembly for fastening of a flat element to a cylinder shaped element. This connection is achieved by means of partially sliding into each other of the elements. During insertion in the direction of the arrow B of the receiving elements 20 in the insertion element, the receiving element 10 is moved into the receiving slot 22. A latching member recess 14 is shown for insertion of a latching member 32′. Advantageously, the latching member 32′is arranged within the dimensions of the receiving element.

A further embodiment (FIG. 7) according to the present invention relates to a fastening assembly for fastening of two flat elements. In this embodiment, a rotatable panel is functional as insertion elements 20. In this embodiment, the biasing member access slots 23 is formed in the frame panel 20 for transverse access of the biasing member when the knob 32 is located in an extended position, relative to the retracted position that is shown. As in the other embodiments, the difference in thickness between the biasing member and the locking member combines both the locking and the ability to pass the biasing member through the biasing member access slot 23. By means of this fastening, these two elements are rotatable relative to each other around a rotational axis E in the mounted condition. This way of fastening of 2 elements can be applied in an advantageous manner by rotatably fastening of a hatch, cap and/or a door.

A further embodiment (FIGS. 8a and 8b) according to the present invention relates to a fastening assembly for fastening of three flat elements. The fastening assembly 1 comprises a receiving element 10, two insertion elements 20, 20′ and a locking assembly 30. The locking assembly 30 comprises two latching members 32, 32′ and a biasing member 31. By means of the substantially symmetrical embodiment of the latching members 32, 32′ with respective locking members 33, 33′, a fastening assembly for two insertion elements 20, 20′ is provided. The biasing member 31 features an elasticity that suffices to unlock one side or both sides simultaneously.

A further embodiment according to FIG. 9 relates to a fastening assembly for fastening of two flat elements with different dimensions. The fastening assembly 1 comprises a receiving element 10, an insertion element 20 and a locking assembly 30. The insertion element is embodied from thicker plate material than the receiving element. The locking assembly comprises two latching members 32, 32′ and a biasing member 31.

In FIG. 10, the fastening assembly according to FIG. 1 is shown in greater detail. The latching member 32 is connected to the latching member 32′ by means of a biasing member 31 which is fastened in the respective knobs of the latching members. Because of this, the stretching length of the biasing member extends from knob to knob. The latching member 32′ comprises a locking member that extends from knob 32 via channel part 12′ and the locking channel into channel part 12.

The insertion element 10 comprises insertion member 20 that is insert able into the receiving position 11. To reinforce the connection, a reinforcement slot 103 is provided for receiving the reinforcement member 104 which is arranged at the top side of the table leg in order to be arrangeable in the reinforcement slot while the fastening element is mounted.

FIGS. 11a and 11b show a connector assembly 200, having a body 203 with U-shaped sections 201, 202. The sections have opposing arms 204, 205 through which holes 207, 208 extend. A locking device 209, 210 extends through the holes, and has locking members or knobs 212, 213 abutting against sidewalls of the arms 204, 204. The locking devices 209, 210 comprise a first elongate body 215 of a relatively large diameter and a second elongate body 216 of a smaller diameter than the first body 215. The body 216 can be formed by an elastic wire, such that the knobs 212 and 213 can be moved apart along the longitudinal axis L. By pulling apart the knobs 212, 213, the narrow body 216 can be made to extend between the arms 204, 205. By releasing the knobs 212, 213, the first body 215 bridges the space between the opposing arms 204, 205.

As best seen in FIG. 11a, the opposing arms 204, 205 of the connector assembly 200 are in assembled state with the locking device 209. The locking device 209 has been inserted into through holes 207, 208 located in each of the opposing arms 204, 205 and being aligned with respect to each other, in such a way that the first elongated body 215 of the locking device 209 is shown in between the opposing arms 204, 205. Moreover, the second elongated body 216 as shown, also shown in FIG. 17b, is partially inserted into the first elongate body 215. By pulling from at least one of the knob 212, 213 away from the opposing knob 212, 213, the connector assembly 200 can be connected to a receiving element 225,226,227 and 228, as best seen in FIG. 15.

FIGS. 12a, 12b show the U-shaped sections 201,202 to extend at an angle of 90 degrees.

FIGS. 13a, 13b show three U shaped sections 201, 202 and 220.

FIGS. 14a and 14b show four U-shaped sections 201, 202, 220 and 221.

FIG. 15 shows four panels 225,226,227 and 228 interconnected via cross-shaped connector assemblies 230, bent connector assemblies 231 and straight connector assemblies 232. Each panel comprises a circumferential edge 235 and a slot 236 through the thickness W of the panels. The slot 236 comprises a wide channel section 237 corresponding in diameter to a diameter of the first body 215. A narrow channel section 238 extends from the section 237 in open communication with the peripheral edge 235. A wide section 239 is present in the panel 228 for receiving the body 203 of the connector assembly. When the body 203 is inserted into the slot 239, the knobs 212, 213 are pulled apart, such that the narrow (for instance elastic wire) body 216 extends across the space between the U-shaped arms 204,205. The body 216 is passed through the narrow channel 238 into the wide channel 237. Thereafter, the knobs 212, 213 are released and the body 203 is locked to the panel by the first elongate body 215 of relatively large diameter entering into the wide channel section 237. As the diameter of the elongate body 215 is larger than the diameter of the narrow channel 238, it cannot me moved to the peripheral edge 235 through the channel 238 such that the locking device 209 and body 203 are locked into place on the panel 228.

In FIG. 16, an exploded view of the connector assembly 200 and the three of the panels 226,227 and 228 as shown in FIG. 15, wherein the connector assembly 200 can be seen in disassembled state.

FIG. 17a shown a potion of one of the panels 226, 227, 228 comprising the wide section 239, being in open communication with the peripheral edge 235. The peripheral edge 235 comprises the slot wherein the body 203 of the connector assembly 230, 231, 232 can be inserted into. As it can be seen, the slot 239 comprises the narrow channel 238 and a closed end in a form of the wide channel 237. It should be noted, that the thickness of the channel W should be independent from the thickness of the connector assembly 230, 231, 232, and that it will be subject to the specific characteristics of the construction.

In FIG. 17b, a cross-section of the locking device 209 is shown, having the first elongate body 215 of a relatively large diameter and the second elongate body 216 of a smaller diameter than the first body 215, being the second elongate body 216 partially inserted into the first elongate body 215. Moreover, the knob 212 is connected to an end of the second elongated body 216; while the second elongated body comprises the knob 213 integrally formed at one of its ends. As illustrated, both ends of the second elongated body 216 comprise an enlarged portion, which can be formed as part of said second elongated body, or just a knob or the like. These end parts of the second elongated body 216 cooperate with the knobs 212, 213 as to keep the second elongated body in engaged position with the knob 212 and first elongated body 215, respectively. As previously mentioned, the second elongate body 216 can be formed by an elastic wire, such that the knobs 212 and 213 can be moved apart along the longitudinal axis L.

FIG. 17c illustrates a connecting part of the connector assembly 230, 231, 232, wherein it can be best seen the U-shaped section of the connector assembly 230, 231, 232 as having the two upstanding opposing arms 204, 205 having through holes 207, 208, which in use, interact with the locking device 209, 210 as to create a fastening assembly for fastening at least two flat elements comprising the wide section 239. As it can be appreciated, the through holes 207, 208 are in line with each other, and have an inner diameter slightly bigger than the outer diameter of the first elongated body 215, as to allow simple connection of the assembly parts.

Advantageous connector assemblies according to the invention may be formed by the following embodiments:

A fastening assembly for mutually fastening of two elements, such as sheet units, comprising:
a receiving element,
an insertion element comprising an insertion member for insertion thereof into a receipt position of the receiving element,
at least one receiving position, arranged in the receiving element, preferably shaped by means of a receiving opening or a receiving recess,
a locking assembly, comprising two latching members and a biasing member for urging towards each other of the latching members, in which at least one of the latching members comprises a locking member for providing a locking between the insertion element and the receiving element:
at least one channel arranged in the receiving element for cooperation with a locking assembly,
in which the channel extends to two sides from the receiving position.

Fastening assembly in which the channel has at least partially a diameter for receiving the locking member, preferably from one side of the channel, therewith forming a locking channel.

Fastening assembly in which at least one end of the channel ends at an edge of the receiving element, further preferably in which two ends of the channel end at two edges of the receiving element.

Fastening assembly in which in the locking assembly, two latching members are arranged at two respective ends of the biasing member, in which the biasing member is elongated.

Fastening assembly in which a first latching member of the locking assembly is suitable for placement in a latching member recess for therein fastening of an end of the biasing member, and a second latching member of the locking assembly is suitable for operating the locking assembly by pulling the second latching member.

Fastening assembly in which both latching members of the locking assembly are suitable for operating the locking assembly by pulling thereof.

Fastening assembly in which both latching members of a locking assembly are provided with a locking member.

Fastening assembly in which an end of the channel ends in the latching member recess, preferably embodied as an opening, through hole or recess that is arranged at an end of the channel at a distance from an edge of the receiving elements.

Fastening assembly in which one of the two latching members is arranged in a respective latching member recess.

Fastening assembly comprising one or two latching member recesses per locking assembly for holding the respective latching members.

Fastening assembly comprising a biasing member access slot for providing access of the biasing member to the channel.

Fastening assembly in which the part of the channel that forms the blocking channel is connected to the edge of the insertion element by means of the biasing member access slot in an insertion direction of the insertion element.

Fastening assembly in which the receiving element comprises a reinforcement slot for reinforcing the coupling between the receiving element and the insertion element, in which preferably the reinforcement slot is arranged in an extension direction of the insertion element relative to the receipt position.

Fastening assembly in which the insertion element is suitable for coupling with a receiving element by means of 2 or more fastening assemblies.

Fastening assembly in which a receiving position relative to the surface of the receiving element is arranged at an angle between 10-117°, preferably 45-135°.

Fastening assembly in which the insertion element comprises a receiving slot for receiving of a part of the receiving element comprising the receiving position, in which a bottom of the receiving slot fulfills the function of the insertion member, preferably comprising a respective biasing member access slot, which further preferably provide access to a respective locking channel part in the respective insertion member.

Fastening assembly in which the locking channel extends from the receiving position to at least one side from the receiving position, preferably from the receiving position to both sides, and in which the locking channel furthermore extends through the insertion member, preferably over the whole length and open contact with the biasing member access slot.

Fastening assembly in which one or both of the latching members have a shape to cooperate with a shape of the receiving element, further preferably with a shape for the purpose of optimal grip or a high attention value.

Fastening assembly in which to receiving positions share a channel for mutual application of a latching assembly, in which the channel preferably extends from the receiving positions in both directions, in which further preferably one or two locking channels are formed in the channel.

Latching assembly for use in a fastening assembly.

Receiving element for use in a fastening assembly.

Insertion element for use in a fastening assembly.

1. Connector assembly comprising a body having two generally U-shaped sections each section having two opposed arms having a hole and a locking device having an elongate locking member extending through the holes of each arm, a first and second latching member attached to each respective end of the locking member abutting against an outward surface of the respective arm, wherein the locking member comprises a first hollow elongate body having a first diameter attached with one end to the first latching member, and a second elongate body that is connected to the first hollow elongate body movably along a longitudinal axis (L) which runs along the first hollow elongate body, the second elongate body having a second diameter that is smaller than the diameter of the first elongate body and being attached with one end to the second latching member.

2. Connector assembly according to claim 1, wherein the second elongate body comprises an elastic biasing member.

3. Connector assembly according to, claim 1 wherein the body is of generally rectangular shape with the U-shaped arms of the sections situated on opposite end sections of the body with their arms extending substantially in the length direction of the body.

4. Connector assembly according to claim 1, the body comprising two end parts extending at a mutual angle of substantially 90 degrees, the U-shaped sections being situated at each end part.

5. Connector assembly according to claim 3, the body comprising three end parts arranged in a generally T-shaped configuration, a U-shaped section being situated at each end part.

6. Connector assembly according to claim 5, the body comprising four end parts arranged in a generally cross-shaped configuration, a U-shaped section being situated in each end part.

7. Connector assembly system comprising one or more connector assemblies according to claim 1, and further comprising at least two panels for connecting to each other using said one or more connector assemblies, each panel having a circumferential edge and a slot having a length direction extending through a thickness (W) of the panel, the slot having a wide channel section situated at a distance from the circumferential edge for receiving the first elongate body, and a narrow channel section communicating with the wide channel section and being open to the circumferential edge, the narrow channel section having a dimension smaller than the first elongate body and allowing the second elongate body to pass from the circumferential edge into the wide channel section.

8. Connector system according to, claim 1 comprising at least two panels being connected, each said panel having a circumferential edge and a slot having a length direction extending through a thickness W of each said panel, the slot having a wide channel section situated at a distance from the circumferential edge for receiving, and a relatively narrow channel section communicating with the wide channel section situated near the circumferential edge and being open to the circumferential edge.

9. Connector system according to claim 8, further comprising the narrow channel section of each said panel connecting at a distance from the circumferential edge to a third channel section that is wider than a diameter of the first channel section and extending from the circumferential edge to the narrow channel section.

10. Connector system according to claim 8, each said panel comprising four corners, two slots extending through each said panel near each corner.

11. (canceled)

12. Connector system according to claim 8, wherein said connector assembly is of rectangular shape with the U-shaped arms situated on opposite end sections of the body with their arms extending substantially in the length direction of the body.

13. Connector system according to claim 8, wherein the body comprising two end parts extends at a mutual axle of about 90°, the two U-shaped sections being situated at each end part.

14. Connector system according to claim 8, wherein three end parts are arranged in a generally T-shaped configuration, wherein one of said two U-shaped sections is each situated at each end part.

15. Connector system according to claim 8, wherein the body comprises four parts in a cross-shaped configuration, and a U-shaped section of said two U-shaped sections is situated in each end part.

16. A fastening system for latching a first element to a second element comprising:
a first element having a first latching surface, a first contact surface and a first fastening channel extending from the first latching surface to the first contact surface;
a second element having a second contact surface abutting the first contact surface spaced at a distance therefrom a second contact surface and a second fastening channel extending from the second contact surface to the second surface in line with the first fastening channel, wherein an access slot of smaller diameter than a diameter of the fastening channels extends from the second fastening channel to an outer surface of the second element and extending parallel to the channel along its length;
a connector assembly comprising a body having two generally U-shaped sections each section having two opposed arms having a hole; and
a locking device having an elongate locking member extending through the holes of each arm, said first and second latching members attached to each respective end of the locking member abutting against an outward surface of the respective arm;
said locking member comprising a first elongate body having a first diameter attached with one end to the first latching member and a free second end, and a second elongate body that is connected at opposite ends thereof to said first and second latching members movably along a longitudinal axis, the second elongate body having a second diameter that is smaller than the diameter of the first elongate body and being said biasing connecting member, said biasing connecting member being elastic.

17. The fastening system according to claim 16, wherein said body of the connector assembly is of generally rectangular shape with the U-shaped arms of the sections situated on opposite end sections of the body with their arms extending substantially in the length direction of the body.

18. The fastening system according to claim 16, wherein said body comprises two end parts extending at a mutual angle of substantially 90 degrees, the U-shaped sections being situated at each end part.

19. The fastening system according to claim 16, wherein the body comprises three end parts arranged in a generally T-shaped configuration, a U-shaped section being situated in each end part.

20. The fastening system according to claim 16, wherein the body comprises four end parts arranged in a generally cross-shaped configuration, a U-shaped section being situated in each end part.

21. The fastening system according to claim 16 comprising at least two panels, each panel having a circumferential edge and a slot having a length direction extending through a thickness of the panel, the slot having a wide channel section situated at a distance from the circumferential edge for receiving the first elongate body, and a narrow channel section communicating with a wide channel section and being open to the circumferential edge, the narrow channel section having a dimension smaller than the first elongate body and allowing the second elongate body to pass from the circumferential edge into the wide channel section.

22. A connector assembly for use in a fastening system comprising:
said connector assembly comprising a body having two generally U-shaped sections each section having two opposed arms having a hole;
a locking device having an elongate locking member extending through the holes of each arm, a first and second latching member attached to each respective end of the locking member abutting against an outward surface of the respective arm; and
said locking member comprising a first elongate body having a first diameter attached with one end to the first latching member and a free second end, and a second elongate body that is connected at opposite ends thereof to said first and second latching members movably along a longitudinal axis, the second elongate body having a second diameter that is smaller than the diameter of the first elongate body and being elastic biasing member.

23. The connector assembly according to claim 22, wherein said body of the connector assembly is of generally rectangular shape with the U-shaped arms of the sections situated on opposite end sections of the body with their arms extending substantially in the length direction of the body.

24. The connector assembly according to claim 22, wherein said body comprises two end parts extending at a mutual angle of substantially 90 degrees, the U-shaped sections being situated at each end part.

25. The connector assembly according to claim 22, wherein the body comprises three end parts arranged in a generally T-shaped configuration, a U-shaped section being situated in each end part.

26. The connector assembly according to claim 22, wherein the body comprises four end parts arranged in a generally cross-shaped configuration, a U-shaped section being situated in each end part.
